(19) United States
(12) Patent Application Publication
(10) Pub. No.: US 2003/0068511 A1
(43) Pub. Date: Apr. 10, 2003

(54) Transparent, multilayer, biaxially oriented polyester film, and process for its production

(76) Inventors: Ursula Murschall, Nierstein (DE); Ulrich Kern, Ingelheim (DE); Thorsten Kiehne, Wiesbaden (DE)

Correspondence Address: ProPat, L.L.C., 2912 Crosby Road, Charlotte, NC, 28211-2815, US

(21) Appl. No.: 10/139,172

(22) Filed: May 6, 2002

(30) Foreign Application Priority Data
May 30, 2001 (DE) 101 26 149.7

(51) Int. Cl. B32B 27/36

(52) U.S. Cl. 428/480; 428/910

(57) ABSTRACT

The invention relates to a transparent, biaxially oriented polyester film with a base layer B which is composed of at least 80% by weight of a thermoplastic polyester, and with at least one outer layer A. Another polymeric layer made from a copolymer crosslinked using an acrylic and/or methacrylic compound, has been applied to that side of the film opposite to the outer layer A. The film has low oxygen transmission and exhibits very good adhesion between the respective layers. The coated film moveover has low coefficient of friction, excellent windability, and excellent antistatic performance. It is particularly suitable for packaging purposes, specifically for packaging foodstuffs or other consumable items. The invention further relates to a process for the production of the film.

### BACKGROUND OF THE INVENTION

1. Field of the Invention

The invention relates to a single- or a multilayer opaquely pigmented, biaxially oriented film which comprises at least one crystallizable thermoplastic as main constituent. It further relates to a process for producing the film.

2. Description of the Related Art

Opaquely pigmented, biaxially oriented films made from crystallizable thermoplastics, in particular from crystallizable polyesters, are known. DE-A 100 12 140 moreover, which is not a prior publication, discloses a flame-retardant, UV-resistant, opaquely pigmented film made from a crystallizable thermoplastic. However, some of the organic flame retardants used therein are moisture-sensitive, and they are therefore used in combination with a hydrolysis stabilizer. Hydrolysis stabilizers disclosed are phenolic compounds, alkali metal stearate, alkaline earth metal stearate, and also alkali metal carbonate or alkaline earth metal carbonate. DE-A 100 43 776, which is not a prior publication, discloses an opaquely pigmented, semicrystalline film made from a bibenzoyl-modified thermoplastic, in particular made from a bibenzoyl-modified polyethylene terephthalate. It may comprise a combination of a flame retardant (preferably an organic phosphorus compound) and a phenolic hydrolysis stabilizer.

Functionalized biaxially oriented films which comprise crystallizable thermo-plastics are also known, and numerous versions of these have been described. An example of the functionalization is that the film is sealable, or has been coated or has been pretreated by a chemical or physical (e.g. corona discharge) method.

The surface of the film may, for example, be modified by suitable treatment or coating so that it becomes sealable, writable or printable, metallizable, sterilizable, or antistatic, or provides an improved odor barrier or improved adhesion to materials which would not otherwise adhere to the film surface (e.g. photographic emulsions). Properties such as UV resistance or flame retardancy can also be established by incorporating additives into the film.

For example, the multilayer, biaxially oriented heat-set polyester film as claimed in GB-A 1 465 973 encompasses a layer made from transparent polyethylene terephthalate (PET) and a layer made from copolyester, likewise transparent. Rollers can be used to emboss a rough structure into the surface of the copolyester layer, making the film writable.

EP-A 035 835 describes a biaxially oriented and heat-set polyester film having more than one layer, encompassing a layer made from a highly crystalline polyester and, bonded thereto, a sealable layer made from a substantively amorphous, linear polyester. The latter layer comprises finely distributed particles, the average diameter of the particles being greater than the thickness of the layer. These particles form surface protrusions which prevent undesirable blocking or adherence to rolls or guiding systems. The result is better winding and processing of the film. The sealing performance of the film is impaired by choosing particles whose diameter is greater than the thickness of the sealable layer, at the concentrations given in the examples. The sealed seam strength of the sealed film at 140° C. is in the range from 63 to 120 N/m (0.97 N/15 mm to 1.8 N/15 mm of film width).

EP-A 432 886 describes a coextruded film with a polyester base layer, and with an outer layer made from a sealable polyester, and with a reverse-side polyacrylate coating. The sealable outer layer may be composed of a copolyester having units derived from isophthalic acid and terephthalic acid. The reverse-side coating gives the film improved processing performance. The sealed seam strength is measured at 140° C. For a sealable layer of 11 μm thickness, the sealed seam strength given is 761.5 N/m (11.4 N/15 mm). A disadvantage of the reverse-side acrylate coating is that this side no longer has sealability to the sealable outer layer. The uses of the film are therefore very restricted.

A coextruded, multilayer sealable polyester film is described in EP-A 515 096. The base layer of the film may comprise pigment particles, in particular made from aluminum oxide, titanium dioxide, alkali metal carbonate, calcium sulfate, or barium sulfate. The result is a white film. The sealable layer also comprises pigment particles, preferably silica gel particles. The particles may also be applied to the film after extrusion, for example by coating with an aqueous silica gel dispersion. This method is intended to give a film whose sealing properties have been retained and which processes well. The reverse side comprises only very few particles, most of which pass into this layer via the regrind. The sealed seam strength is measured at 140° C. and is above 200 N/m (3 N/15 mm). The sealed seam strength given for a sealable layer of 3 μm thickness is 275 N/m (4.125 N/15 mm).

WO 98/06575 discloses a coextruded multilayer polyester film encom-passing a sealable outer layer and a non-sealable base layer. This base layer may have been built up from one or more layers, the interior layer being in contact with the sealable layer. The other (exterior) layer then forms the second, non-sealable outer layer. Here too, the sealable outer layer may be composed of copolyesters having units derived from isophthalic acid and terephthalic acid. However, no antiblocking particles are present in the outer layer. The film also comprises at least one UV absorber, present in a proportion of from 0.1 to 10% by weight in the base layer. The UV absorbers used in this instance are zinc oxide particles or titanium dioxide particles, in each case with an average diameter below 200 nm, but preferably triazines, (e.g. ®Tinuvin 1577 from Ciba). The base layer has conventional antiblocking agents. The film has good sealability, but not the desired processing performance, and also has shortcomings in its optical properties.

Layers made from copolyester can be produced by applying an appropriate aqueous dispersion. For example, EP-A 144 878 describes a polyester film which, on at least one side, has a continuous coating made from the copolyester. The dispersion is applied to the film prior to orientation or, respectively, prior to the final step of orientation. The polyester coating is composed of a condensation product of various monomers capable of forming polyesters, for example isophthalic acid, aliphatic dicarboxylic acids, sulfomonomers, and aliphatic or cycloaliphatic glycols.

DE-A 23 46 787 discloses, inter alia, flame-retardant films made from linear polyesters, modified with carboxyphosphinic acids. However, production of these films is attended by a variety of problems, for example, the raw material is very susceptible to hydrolysis and requires very thorough predrying. When the raw material is dried using prior art dryers it cakes, and production of a film is possible only under very difficult conditions. The films produced, under extreme and uneconomic conditions, also embrittle at high temperatures. The associated decline in mechanical properties is so severe as to make the film unusable. This embrittlement arises after as little as 48 hours at high temperature.

However, none of these known films is sufficiently hydrolysis-resistant. Their shrinkage properties are moreover not ideal, the result being that in many applications the films cannot be used.

### SUMMARY OF THE INVENTION

An object was therefore to provide an opaquely pigmented, biaxially oriented film which has good mechanical and optical properties, has low shrinkage, does not embrittle after heating, is capable of cost-effective production, and, furthermore, is highly resistant to water or moisture and can also be provided with additional functionalities.

This object has been achieved with the aid of least one monomeric, oligomeric or polymeric carbodiimide, incorporated as hydrolysis stabilizer into the film. Surprisingly, no losses of optical or mechanical properties occur in the film.

The present invention therefore provides a single- or multilayer opaquely pigmented, biaxially oriented film which comprises at least one crystallizable thermoplastic as main constituent and comprises at least one pigment, and which comprises at least one monomeric, oligomeric, or polymeric carbodiimide.

The monomeric, oligomeric, or polymeric carbodiimides are capable of regenerating ester bonds broken by hydrolysis. Preferred carbodiimides are linear aliphatic carbodiimides, such as dicyclohexyl carbodiimide, and aromatic polymeric carbodiimides, particular preference among the last-named being given to those with a molecular weight of from 2000 to 50 000 and with a melting range of from 50 to 300° C., preferably from 60 to 200° C. (obtainable, for example, with the name ®Stabaxol P from Rhein Chemie GmbH, Mannheim, Germany). The proportion of these compounds is generally from 0.1 to 5.0% by weight, preferably from 0.2 to 3.0% by weight, based in each case on the weight of the single-layer film or of the layer provided therewith in the multilayer film.

The monomeric, oligomeric, or polymeric carbodiimides may, where appropriate, be used in combination with other hydrolysis stabilizers. Examples of these are phenolic compounds and oxazolines. Particularly suitable phenolic compounds are sterically hindered phenols, thiobisphenols, alkylidenebisphenols, alkylphenols, hydroxybenzyl compounds, acylaminophenols, and hydroxyphenyl-propionates (in particular the 3,5-di-tert-butyl-4-hydroxyphenylpropionates of pentaerythritol and of 1-octadecanol, obtainable as ®Irganox from Ciba Specialty Chemicals). An example of a description of these compounds is found in the monograph “Kunststoffadditive” [Plastics additives] by Gächter and Müller, 2nd edn., Carl HanserVerlag. The proportion of the phenolic stabilizers is usually from 0.1 to 8.0% by weight, preferably from 0.2 to 5.0% by weight, based in each case on the weight of the film or, respectively, of the layer provided therewith (in the case of the multilayer film).

Phenolic stabilizers are preferably combined with organic phosphites, in particular with triaryl phosphites (for example those obtainable as ®Irgafos 168 from Ciba Specialty Chemicals). These are capable of degrading peroxides and therefore act as secondary stabilizers. The ratio by weight of phenolic stabilizers to organic phosphites here is generally from 10:90 to 90:10. Mixtures of primary and secondary hydrolysis stabilizers are also commercially available, for example as ®Irganox B 561 or ®Irganox B 225.

### DETAILED DESCRIPTION OF THE PREFERRED EMBODIMENTS

One preferred film of the invention comprises compounds which reduce hydrolysis rate (for example phenolic compounds) and also compounds which can restore ester bonds. It is particularly resistant to moisture or water. In one preferred embodiment, the film therefore comprises from 0.1 to 5% by weight of polymeric aromatic carbodiimides and from 0.1 to 5% by weight of a blend made from 30 to 90% by weight of an organic phosphite (in particular a triaryl phosphite) and 70 to 10% by weight of a hydroxyphenylpropionate. The proportion of all of the hydrolysis stabilizers together is generally from 0.2 to 13.0% by weight, preferably from 0.4 to 8.0% by weight, based in each case on the weight of the film or, respectively, of the relevant layer of the multilayer film.

The absorbance of the hydrolysis stabilizers at wavelength 380-400 nm is practically zero, or only very small when compared with that of UV stabilizers.

The single-layer film, or at least one layer of the multilayer film, has been obliquely pigmented with at least one pigment. The pigment is preferably an inorganic white pigment, an inorganic or organic non-neutral-color pigment, an inorganic black pigment, or a mixture of these. In the case of the multilayer films, the location of the pigment is preferably in the base layer, but may also, either instead or additionally, be in the outer layer(s) and/or in the intermediate layers which may be present.

The pigment is preferably fed in the form of a masterbatch but may also be incorporated directly at the premises of the raw material producer.

Preferred white pigments are titanium dioxide, barium sulfate, calcium carbonate, kaolin, silicon dioxide, particularly preferably titanium dioxide (anatase or rutile type) and barium sulfate. Titanium dioxide does not give rise to any vacuoles in the polymer matrix during film production. The titanium dioxide pigment particles may have been coated, in particular with a covering of inorganic oxides. Coated particles of this type are known and are used, for example, in papers or paints to improve lighffastness. TiO₂ is photoactive. On exposure to UV radiation, free radicals form on the surface of the particles. The free radicals are in turn capable of initiating degradation reactions in the film-forming polymers, this being particularly noticeable through yellowing of the film. In one preferred embodiment, the TiO₂ particles have been coated with oxides of aluminum, of silicon, of zinc, or of magnesium, or with a mixture of various oxides. EP-A 044 515 and EP-A-078 633, for example, disclose TiO₂ particles with a covering made from a number of these compounds. The covering may moreover comprise organic compounds having polar and nonpolar groups. The organic compounds have to have sufficient thermal stability during production of the film via extrusion of the polymer melt. Examples of polar groups are —OH; —OR; —COOX; (X=R; H or Na, R=alkyl having 1-34 carbon atoms). Preferred organic compounds are alkanols and fatty acids having 8-30 carbon atoms, in particular fatty acids and primary n-alkanols having 12-24 carbon atoms, and also polydiorganosiloxanes and/or polyorganohydrosiloxanes, such as polydimethylsiloxane and polymethyl-hydrosiloxane. The titanium dioxide pigment particles have generally been coated with from 1 to 12 g, preferably from 2 to 6 g, of inorganic oxides, and from 0.5 to 3 g, preferably from 0.7 to 1.5 g, of organic compounds, based on 100 g of titanium dioxide particles. The covering is particularly advantageously applied with the aid of an aqueous suspension. The inorganic oxides in the aqueous suspension here may be precipitated from water-soluble compounds—e.g. an alkali metal nitrate, in particular sodium nitrate, sodium silicate (waterglass), or silica.

The term inorganic oxides, such as Al₂O₃ or SiO₂, also includes the hydroxides, and also the various dehydration states of the oxides, such as oxide hydrates, the precise composition and structure here often being unknown. The oxide hydrates, e.g. of aluminum and/or silicon, are precipitated onto the calcined and ground TiO₂ pigment, in aqueous suspension, and the pigments are then washed and dried. This precipitation may therefore take place directly in a suspension such as that produced within the production process after calcination followed by wet-grinding. The oxides and/or oxide hydrates of the respective metals are precipitated from the water-soluble metal salts within the known pH range: for example, for aluminum use is made of aluminum sulfate in aqueous solution (pH below 4), and the oxide hydrate is precipitated within the pH range from 5 to 9, preferably from 7 to 8.5, by adding aqueous ammonia solution or sodium hydroxide solution. If the starting material is waterglass solution or alkali metal aluminate solution, the pH of the initial charge of TiO₂ suspension should be within the strongly alkaline range (pH above 8). The precipitation then takes place within the pH range from 5 to 8, by adding mineral acid, such as sulfuric acid. Once the metal oxides have been precipitated, the stirring of the suspension is continued for from 15 min to about 2 h, aging the precipitated layers. The coated pigment is separated off from the aqueous dispersion, washed, and dried at an elevated temperature, preferably at from 70 to 100° C.

In another preferred embodiment, the pigment is barium sulfate, and the proportion here of the barium sulfate is generally from 0.2 to 40% by weight, preferably from 0.3 to 25% by weight, particularly preferably from 1 to 25% by weight, based in each case on the weight of the crystallizable thermoplastic. Like the other pigments, the barium sulfate, too, is preferably fed in the form of a masterbatch directly during film production.

In one preferred embodiment, precipitated grades of barium sulfate are used. Precipitated barium sulfate is obtained from barium salts with sulfates or sulfuric acid, as a fine-particle colorless powder whose particle size can be controled via the conditions of precipitation. Precipitated barium sulfates may be prepared by the conventional processes described in Kunststoff-Journal, 8 [1974], No. 10, pp. 30-36 and Nr. 11, pp. 26-31. The average particle size is relatively small, preferably within the range from 0.1 to 5 μm, particularly preferably within the range from 0.2 to 3 μm. The density of the barium sulfate used is usually from about 4 to 5 g/cm³.

In the event of pigmentation using barium sulfate, the film advantageously also comprises at least one optical brightener, the amount used of the optical brightener being from 10 to 50 000 ppm, in particular from 20 to 30 000 ppm, particularly preferably from 50 to 25 000 ppm, in each case based on the weight of the crystallizable thermoplastic. The optical brightener, too, is preferably added with the aid of masterbatch technology directly during film production. Optical brighteners are capable of absorbing UV radiation in the region from 360 to 380 nm and of re-emitting this in the form of longer-wavelength visible blue-violet light. Suitable optical brighteners are benzoxazol derivatives, triazines, phenyl-coumarins, and bis-styrylbiphenyls. Examples of brighteners of this type are obtainable with the name ®Tinopal from Ciba Specialty Chemicals, Basle, Switzerland, ®Hostalux KS from Clariant Deutschland GmbH, or ®Eastobrite OB-1 from Eastman, USA.

Besides the optical brightener, one or more blue dyes soluble in the thermoplastic may also be present, where appropriate, in the film. Suitable blue dyes have proven to be ultramarine blue and anthraquinone dyes, in particular Sudan Blue 2 from BASF AG, Ludwigshafen, Germany. The proportion of the blue dye(s) is generally from 10 to 10 000 ppm, preferably from 20 to 5000 ppm, particularly preferably from 50 to 1000 ppm, based in each case on the weight of the at least one crystallizable thermoplastic.

In one particularly preferred embodiment, the film of the invention comprises a crystallizable polyethylene terephthalate as main constituent, and also from 1 to 25% by weight of precipitated barium sulfate, advantageously with a particle diameter of from 0.4 to 1 μm, particular preference being given to ®Blanc fixe XR-HX or ®Blanc fixe HXH from Sachtleben Chemie.

In another embodiment, the film of the invention has color pigmentation. In the case of the multilayer film, an inorganic or organic non-neutral-color pigment and/or an inorganic black pigment may be present in the base and/or outer layer(s).

The inorganic black pigments include in particular various carbon black pigments (flame, channel, or furnace blacks), which may also have been coated, and also carbon pigments which differ from the carbon black pigments in having higher ash content, and oxidic black pigments, such as iron oxide black and mixtures of copper pigments, chromium pigments, and iron oxide pigments (mixed-phase pigments).

Suitable inorganic non-neutral-color pigments are oxidic color pigments, hydroxy-containing pigments, sulfidic pigments, and chromates. Examples of oxidic non-neutral-color pigments are iron oxide red, titanium oxide/nickel oxide/antimony oxide mixed-phase pigments, titanium dioxide/chromium oxide pigments, antimony oxide mixed-phase pigments, mixtures of oxides of iron, of zinc, and of titanium, chromium oxide, iron oxide brown, spinelles of the cobalt/aluminum/titanium/nickel/zinc oxide system, and mixed-phase pigments based on other metal oxides. Examples of typical hydroxy-containing pigments are oxide-hydroxides of trivalent iron, such as FeOOH. Examples of sulfidic pigments are cadmium sulfide-selenides, cadmium/zinc sulfides, and also sodium/aluminum silicates in which sulfur is present in the lattice with polysulfide-type bonding. Examples of chromates are lead chromates, whose crystalline forms may be monoclinic, rhombic,.or tetragonal.

The organic non-neutral-color pigments are generally divided into azo pigments and what are known as non-azo pigments. A characteristic of the azo pigments is the azo (—N═N—) group. Azo pigments may be monoazo pigments, diazo pigments, diazo condensation pigments, salts of azo dye acids, or a mixture of the azo pigments. Like the white and black pigments, the non-neutral-color pigments may be uncoated or have been coated with inorganic and/or organic substances. The black or non-neutral-color pigment is preferably fed in the form of a masterbatch, but may also be incorporated directly at the premises of the raw material producer.

The proportion of the pigment or pigment mixture is generally from 0.2 to 40% by weight, preferably from 0.3 to 25% by weight, based in each case on the weight of the crystallizable thermoplastic of the relevant layer.

The film of the invention comprises a crystallizable thermoplastic as main constituent, in particular a crystallizable polyester or copolyester. Examples of suitable crystallizable or semicrystalline (co)polyesters are polyethyelene terephthalate (PET), polyethylene naphthalate (PEN), polybutylene terephthalate (PBT), bibenzoyl-modified polyethylene terephthalate (PETBB), bibenzoyl-modified polybutylene terephthalate (PBTBB), and bibenzoyl-modified poly-ethylene naphthalate (PENBB), preference being given to polyethylene tere-phthalate (PET) and bibenzoyl-modified polyethylene terephthalate (PETBB).

For the purposes of the present invention, “crystallizable thermoplastics” are crystallizable homopolymers, crystallizable copolymers, crystallizable compositions, crystallizable recycled material, or many other type of crystallizable thermoplastic.

Substances which may be used for preparing crystallizable, thermoplastic (co)polyesters, besides the main monomers, such as dimethyl terephthalate (DMT), ethylene glycol (EG), propylene glycol (PG), 1,4-butanediol, terephthalic acid (TA), benzenedicarboxylic acid, and/or naphthalene-2,6-dicarboxylic acid (NDA), are isophthalic acid (IPA) and/or cis- and/or trans-1,4-cyclohexane-dimethanol (c-CHDM, t-CHDM, or c/t-CHDM).

The standard viscosity SV (DCA) of the polyethylene terephthalate is generally from 600 to 1000, preferably from 700 to 900.

Preferred starting materials for producing the film of the invention are crystallizable thermoplastics with a crystalline melting point Tm of from 180 to 365° C. or above, preferably from 180 to 310° C., and with a crystallization temperature range Tc of from 75 to 280° C., and with a glass transition temperature Tg of from 65 to 130° C. (determined by differential scanning colorimetry (DSC) at a heating rate of 20° C./min) and with a density from 1.10 to 1.45 (determined to DIN 53479), and with a crystallinity of from 5 to 65%, preferably from 20 to 65%.

The bulk density (measured to DIN 53466) is from 0.75 to 1.0 kg/dm³, preferably from 0.80 to 0.90 kg/dm³.

The polydispersity (or Mw:Mn ratio) of the thermoplastic, measured by gel permeation chromatography (GPC) is preferably from 1.5 to 4.0, particularly preferably from 2.0 to 3.5.

“Main constituent” means that the proportion of the at least one semicrystalline thermoplastic is preferably from 50 to 99% by weight, particularly preferably from 75 to 95% by weight, based in each case on the total weight of the film or, respectively, on the total weight of the layer within the film. The remaining content may be made up by the hydrolysis stabilizer and other additives usually used for biaxially oriented, transparent films.

The film of the invention may be a single- or multilayer film. In the multilayer embodiment, the film is composed of at least one core layer, of at least one outer layer, and, where appropriate, of at least one intermediate layer, and particular preference is given here to an A-B-A or A-B-C three-layer structure. In this embodiment it is important that the standard viscosity of the crystallizable thermoplastic of the core layer is similar to that of the crystallizable thermoplastic of the outer layer(s) which adjoin(s) the core layer. Again, the thermoplastic is preferably a polyethylene terephthalate.

In one particular embodiment, the outer layers and/or the intermediate layers of the multilayer film may also be composed of a polyethylene naphthalate homopolymer, or of polyethylene terephthalate-polyethylene naphthalate copolymers, or of a compound. In this embodiment, the standard viscosities of the thermoplastics of the outer layers are again similar to that of the polyethylene terephthalate of the core layer.

In the multilayer embodiment, the hydrolysis stabilizer(s) is/are preferably present in the base layer. However, depending on requirements, it is also possible for the outer layers and/or any intermediate layers present to have hydrolysis stabilizers, at the concentration stated for the monofilm. Unlike in the single-layer embodiment, the concentration of the stabilizers here is based on the weight of the layer provided with the materials.

The film of the invention has good mechanical properties. These include high modulus of elasticity (longitudinally=in machine direction (MD) greater than 3200 N/mm², preferably greater than 3500 N/mm²; in transverse direction (TD) greater than 3500 N/mm², preferably greater than 3800 N/mm²; in each case determined to ISO 527-1-2), and also good values for tensile stress at break (in MD more than 100 N/mm²; in TD more than 130 N/mm².

It also has low shrinkage. This means that the shrinkage of the film both longitudinally and transversely is less than 2.0%, preferably less than 1.8%, particularly preferably less than 1.6%, after 15 min of heating to 150° C. (DIN 40 634). These shrinkage values may be achieved byway of the production process, or else by subsequent off-line post-treatment. In the off-line post-treatment, the film is conducted, very substantially without tension, through an oven where it is exposed to a temperature in the range from 160 to 210° C. for from 1 second to 2 minutes. The shrinkage may be established during the production process via adjustment of the heat-setting temperature. The heat-setting temperature is from 180 to 260° C., in particular from 220 to 250° C.

The film also has excellent capability for both longitudinal and transverse orientation during its production, with no break-offs. The oriented film generally has a thickness of from 1 to 500 μm, preferably from 5 to 350 μm, particularly preferably from 10 to 300 μm.

The film of the invention also has good hydrolysis resistance. That means that its tensile stress at break is more than 100 N/mm² longitudinally and transversely after 1000 hours at 85° C. and 95% relative humidity in an autoclave in the heat/humidity test (long-term humidity test). It therefore passes the heat/humidity test usually used in the automotive industry. In contrast to this, PET films without hydrolysis stabilizers are non-compliant with this test.

In addition, the film does not embrittle when exposed to heat. This means that even after 1000 hours of heat-conditioning at 130° C. in a circulating-air heating cabinet there is only insignificant impairment of the mechanical properties of the film.

An example of the good optical properties of the film is low light transmittance (less than 85%, preferably less than 82%), low rays (less than 30%), and also low Yellow Index (YI less than 30, preferably less than 28). In view of the hydrolysis stability achieved, these values are surprisingly good.

The film may also be produced cost-effectively. For example, the raw materials or raw material components needed to produce the film may be dried using conventional industrial dryers, such as vacuum dryers, fluidized-bed dryers, or fixed-bed dryers (power dryers) without any caking of the raw materials or thermal degradation of the same.

The film of the invention may moreover be recycled without polluting the environment, and the film produced from the recycled material exhibits practically no impairment of optical properties (in particular in the case of the Yellowness Index) or of mechanical properties in comparison with a film produced from virgin starting materials.

The base layer and/or outer layer(s) may also comprise other conventional additives, such as stabilizers and antiblocking agents, besides the hydrolysis stabilizer(s) and the additives described above. The other additives are advantageously added to the polymer or polymer mixture before melting begins.

Mixtures of two or more different antiblocking agents or mixtures of antiblocking agents of the same composition but different particle size may also be chosen as additives. The usual proportions of the particles, e.g. in the form of a glycolic dispersion, may be added to the individual layers, during poly-condensation, or by way of masterbatches during extrusion. Proportions of from 0.0001 to 10.0% by weight of pigment, based on the weight of the outer layers, have proven particularly suitable.

The film of the invention may also have been functionalized, i.e. may, for example, be sealable or have been flame-treated and/or corona-treated, rendered UV-resistant, or chemically pretreated, depending on requirements.

One embodiment of the film is UV-resistant. Light, in particular the ultraviolet content of solar radiation, i.e. the wavelength region from 280 to 400 nm, causes degradation in thermoplastics, the results of which are not only a change in appearance due to color change or yellowing but also an extremely adverse effect on the mechanical and physical properties of films made from these thermoplastics. The suppression of this photooxidative degradation is of considerable industrial and economic importance, since without it many thermoplastics have drastically reduced scope of application. The absorption of UV light by polyethylene terephthalates, for example, start below 360 nm, increasing markedly below 320 nm, and is very pronounced below 300 nm. Maximum absorption occurs at between 280 and 300 nm. In the presence of oxygen it is mainly chain cleavage which is observed, but without any crosslinking. The predominant photooxidation products in quantity terms are carbon monoxide, carbon dioxide and carboxylic acids. Besides direct photolysis of the ester groups, attention has to be paid to oxidation reactions which proceed via peroxide radicals, again to form carbon dioxide. In photooxidation of polyethylene terephthalates there can also be cleavage of hydrogen at the position a to the estergroups, giving hydroperoxides and decomposition products of these, and this may be accompanied by chain cleavage (H. Day, D. M. Wiles, J. Appl. Polym. Sci. 16 [1972] p. 203).

UV stabilizers, i.e. light stabilizers which are UV absorbers, are chemical compounds which intervene in the physical and chemical processes of light-induced degradation. Carbon black and other pigments can give some protection from light, but these substances are unsuitable for transparent films, since they cause discoloration or color change. UV stabilizers which are suitable light stabilizers are those which absorb at least 70%, preferably at least 80%, particularly preferably at least 90%, of the UV light in the wavelength region from 180 to 380 nm, preferably from 280 to 350 nm. These are particularly suitable if they are thermally stable, i.e. do not decompose into cleavage products, nor cause any evolution of gas, in the temperature range from 260 to 300° C. Examples of UV stabilizers which are suitable light stabilizers are 2-hydroxy-benzophenones, 2-hydroxybenzotriazoles, organonickel compounds, salicylic esters, cinnamic ester derivatives, resorcinol monobenzoate, oxanilides, hydroxybenzoic esters, benzoxazinones, sterically hindered amines and triazines, preference being given to the 2-hydroxybenzotriazoles, the benzoxazinones and the triazines. For the skilled worker it was highly surprising that the use of UV stabilizers in combination with hydrolysis stabilizers leads to useful films with excellent properties. The skilled workerwould probably have begun by attempting to achieve a certain level of UV resistance by using an antioxidant, but after weathering would have found that the film rapidly yellows.

There are UV stabilizers known from the literature which absorb UV radiation and therefore provide protection. The skilled workerwould then probably have used one of these known and commercially available UV stabilizers, but in doing this would have found that the UV stabilizer lacks thermal stability and evolves gases or decomposes at temperatures from 200 to 240° C. In order to prevent damage to the film, the skilled worker would have had to incorporate large amounts (from about 10 to 15% by weight) of UV stabilizer, so that the UV light is really effectively absorbed by the stabilizer. However, at these high concentrations the film yellows within just a short period after its production. Its mechanical properties are also adversely affected. Extraordinary problems would have been encountered on orientation, for example break-off due to lack of strength, i.e. modulus of elasticity, die deposits, causing variations in profile, roller deposits from the UV stabilizer, an effect which causes impairment of optical properties (excessive haze, adhesion problems, non-uniform surface), and deposits in the stretching and setting frames, dropping onto the film. It was therefore surprising that even low concentrations of the UV stabilizer achieve exceptional UV protection. When comparison is made with an unstabilized film, it was particularly surprising that, within the limits of accuracy of measurement, there is no change here in the Yellowness Index of the film. In addition, the film has excellent optical properties, outstandingly good profile, and outstandingly good layflat. The UV-resistant film has excellent capability for orientation, and is therefore capable of stable production by a process which is reliable. This means that production of the film is also cost-effective. It is also very surprising that it is even possible to reuse the regrind without adversely affecting the Yellowness Index of the film.

In one particularly preferred embodiment, the film of the invention comprises, as UV stabilizer, from 0.1 to 5.0% by weight of 2-(4,6-diphenyl-[1,3,5]-triazin-2-yl)-5-hexyloxyphenol of the formula

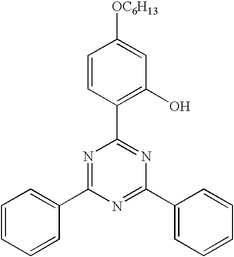

or from 0.1 to 5.0% by weight of2,2′-methylenebis[6-benzotriazol-2-yl4-(1,1,2,2-tetramethylpropyl)phenol] of the formula

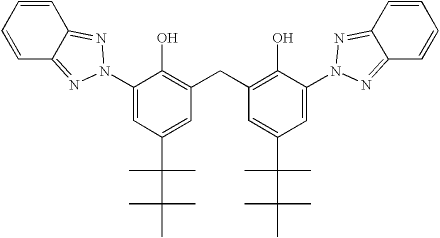

or from 0.1 to 5.0% by weight of 2,2′-(1,4-phenylene)bis([3,1]benzoxazin-4-one) of the formula

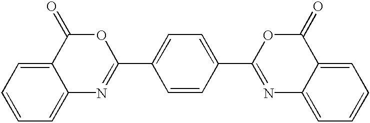

In another embodiment, it is also possible for mixtures of these UV stabilizers to be used, or mixtures of at least one of these UV stabilizers with other UV stabilizers, the total concentration of light stabilizers preferably being from 0.1 to 5.0% by weight, particularly preferably in the range from 0.5 to 3.0% by weight, based on the weight of the layer provided with the materials.

In another embodiment, the film of the invention has been made flame-retardant. For the purposes of the present invention, the term flame retardant implies that the film complies with the conditions of DIN 4102 Part 2, and in particular the conditions of DIN 4102 Part 1 in tests known as fire-protection tests, and can be assigned to construction materials class B2, and in particular B1, for low-flammability materials. When it is appropriate for the film to be flame-retardant, it should also pass the UL 94 “Horizontal Burning Test for Flammability of Plastic Material”, to the extent that it can be placed in class 94 VTM-0. In this case, the film comprises a flame retardant, which is fed directly by way of what is known as masterbatch technology during film production, the proportion of the flame retardant being in the range from 0.5 to 30.0% by weight, preferably from 1.0 to 20.0% by weight, based on the total weight of the single-layer film, or of the relevant layer of the multilayer film. The proportion of the flame retardant in the masterbatch is generally from 5 to 60% by weight, preferably from 10 to 50% by weight, based in each case on the total weight of the masterbatch. The flame retardant here is dispersed in the carrier material, or else may have been chemically bonded within the thermoplastic. Examples of suitable flame retardants are bromine compounds, chloroparaffins and other chlorine compounds, antimony trioxide, and alumina trihydrates. However, the halogen compounds have the disadvantage that halogenated byproducts can be produced. In particular, hydrogen halides are produced in the event of a fire. Another disadvantage is that films provided with these materials have low light resistance. Examples of other suitable flame retardants are monomeric or polymeric, cyclic or acyclic, organophosphorus compounds, such as carboxyphosphinic acids and/or anhydrides of these, and also alkanephosphonic esters, preferably methanephosphonates, such as bis(5-ethyl-2-methyl-2-oxo-2λ5-[1,3,2]dioxaphosphinan-5-ylmethyl)methanephosphonate. It is important that the organic phosphorus compound is soluble in the thermoplastic, since otherwise the optical properties required are not complied with. Very surprisingly, fire-protection tests to DIN 4102 and the UL test have shown that in order to provide improved flame retardancy in a three-layer film it is entirely sufficient to provide flame retardants in the outer layers whose thickness is from 0.5 to 2 μm. If required, and if fire-protection requirements are stringent, the core layer may also have what is known as a base level of flame retardants.

The flame-retardant film also exhibits no embrittlement and no impairment of mechanical properties after 1000 hours of heat-conditioning at 130° C. in a circulating-air heating cabinet, and therefore passes the heat/moisture test used by the automotive industry. In contrast, flame-retardant films which are not hydrolysis-resistant exhibit marked embrittlement after the heat-conditioning described.

Known processes may also have been used to provide one or both sides of the film with a conventional functional coating. Examples of materials which may be used to produce the coating are: acrylates as in WO 94/13476, ethylene-vinyl alcohols, PVDC, waterglass (Na₂SiO₄), hydrophilic polyesters, such as PET/IPA polyesters containing the sodium salt of 5-sulfoisophthalic acid (EP-A 144 878, U.S. Pat. No. 4,252,885 or EP-A 296 620), vinyl acetates (WO 94/13481), polyvinyl acetates, polyurethanes, the alkali metal or alkaline earth metal salts of C₁₀-C₁₈ fatty acids, and copolymers having units of butadiene and acrylonitrile, or of (meth)acrylic acid or of an alkyl (meth)acrylate. The coating may also comprise conventional additives (e.g. antiblocking agents, pH stabilizers) in proportions of from about 0.05 to 5.0% by weight, preferably from 0.1 to 3.0% by weight, in each case based on the weight of the coating liquid.

The substances or compositions mentioned are applied in the form of dilute, preferably aqueous, solution, emulsion, or dispersion to one or more both sides of the film. The solvent is then evaporated. The coating is preferably applied in-line, i.e. during the film production process, advantageously prior to transverse stretching. Particular preference is given to application by the reverse gravure-roll coating process, which gives extremely uniform layer thicknesses. If the in-line coatings are applied after longitudinal stretching, the heat treatment prior to transverse stretching is usually sufficient to evaporate the solvent and dry the coating. The thicknesses of the dried coatings are then from 5 to 100 nm, preferably from 20 to 70 nm, in particular from 30 to 50 nm.

For particular applications, it can also be advantageous to use treatment with acids for chemical pretreatment of one or both sides of the film. Trichloroacetic acid, dichloroacetic acid or hydrofluoric acid are particularly suitable for this process, which is known as adhesion etching, and act on the surface for a short period (from about 1 to 120 seconds), and are then removed, advantageously with the aid of what is known as an air knife. Where appropriate, the film is then dried. The resultant film has a very reactive, amorphous surface.

If very good sealability is demanded, and if this property cannot be achieved via in-line coating, the film of the invention then has a structure of at least three layers and in one particular embodiment then encompasses the base layer B, a sealable outer layer A, and an outer layer C which may, where appropriate, be sealable. If the outer layer C is also sealable, it is then preferable for the two outer layers to be identical.

The sealable outer layer A applied by coextrusion to the base layer B has a structure based on polyester copolymers and essentially consists of copolyesters composed predominantly of isophthalic acid units, bibenzoyl units, and terephthalic acid units, and of ethylene glycol units. The remaining monomer units derive from the other aliphatic, cycloaliphatic, or aromatic diols and, respectively, dicarboxylic acids which may be present in the base layer. The preferred copolyesters providing the desired sealing properties are those built up from ethylene terephthalate units and ethylene isophthalate units, and from ethylene glycol units. The proportion of ethylene terephthalate is from 40 to 95 mol %, and the corresponding proportion of ethylene isophthalate is from 60 to 5 mol %. Preference is given to copolyesters in which the proportion of ethylene terephthalate is from 50 to 90 mol % and the corresponding proportion of ethylene isophthalate from 50 to 10 mol %, and a high level of preference is given to copolyesters in which the proportion of ethylene terephthalate is from 60 to 85 mol % and the corresponding proportion of ethylene isophthalate is from 40 to 15 mol %.

For the outer layer C which may, where appropriate be sealable, and for any intermediate layers present it is possible in principle to use polymers which are identical to those used in the base layer.

The desired sealing properties and processing properties of the film of the invention are obtained by combining the properties of the copolyester used for the sealable outer layer with the topographies of the sealable outer layer A and of the outer layer C which may, where appropriate, be sealable.

The minimum sealing temperature of 110° C. and the sealed seam strength of at least 1.3 N/15 mm are achieved if the copolymers described in some detail above are used for the sealable outer layer A. The best sealing properties are obtained for the film if no other additives are used with the copolymer, in particular no inorganic or organic fillers. This gives the lowest minimum sealing temperature and the highest sealed seam strengths, for a given copolyester. However, it also gives poor film handling, since the surface of the sealable outer layer A is highly susceptible to blocking. The film is almost impossible to wind and is unsuitable for further processing on high-speed packaging machinery. To improve the handling of the film and its processibility, it is necessary to modify the sealable outer layer A. This is best done with the aid of suitable antiblocking agents of selected size, these being added to the sealable layer at a certain concentration and specifically in such a way as firstly to minimize blocking and secondly to give no significant impairment of sealing properties.

To establish other desired properties, the film may be corona- or flame-treated. The treatment is generally carried out in such a way that the resultant surface tension of the film is generally above 45 mN/m.

The base layer and/or outer layer(s) may also comprise other conventional additives, such as stabilizers and antiblocking agents, besides the hydrolysis stabilizer(s) and the additives described above. The other additives are advantageously added to the polymer or polymer mixture before melting begins.

The present invention also provides a process for producing the film. It is generally produced by extrusion or coextrusion, for example on an extrusion line. It has proven particularly advantageous to add the hydrolysis stabilizer(s) in the form of a predried or precrystallized masterbatch, prior to extrusion or coextrusion. The proportion of hydrolysis stabilizer(s) in the masterbatch is generally from 5 to 50% by weight, preferably from 6 to 30% by weight, in each case based on the total weight of the masterbatch. The hydrolysis stabilizer(s) are fully dispersed in a carrier material. Carrier materials which may be used are the thermoplastic itself, e.g. polyethylene terephthalate, or else other polymers compatible with the thermoplastic.

It has proven particularly advantageous for the particle size and the bulk density of the masterbatches to be identical with or similar to the particle size and the bulk density of the thermoplastic. Homogeneous distribution is then achieved, and the resultant film has particularly consistent properties.

The films of the invention may be produced either as single-layer or as multilayer—where appropriate coextruded—films, by known processes, from a polyester, where appropriate with other raw materials, at least one hydrolysis stabilizer, and also other conventional additives where appropriate (these latter in the usual amounts of from 0.1 to 30% by weight, based on the weight of the film). The surfaces of the films may be identical or different in nature. For example, one surface may comprise particles while the other does not, or all of the layers may comprise particles. One or both surfaces of the film may also be provided with a functional coating, using known processes.

Masterbatches comprising the hydrolysis stabilizer(s) should have been precrystallized or predried. This predrying includes gradual heating of the masterbatches at reduced pressure (from 20 to 80 mbar, preferably from 30 to 60 mbar, in particular from 40 to 50 mbar), and also agitation and, where appropriate, post-drying at a constant elevated temperature (likewise at reduced pressure). The masterbatches are preferably charged batchwise at room temperature from a feed vessel, in the desired blend together with the polymers of the base layer and/or outer layers and, where appropriate, with other raw material components, into a vacuum dryer which in the course of the drying period or residence time, traverses a temperature profile of from 10 to 160° C., preferably from 20 to 150° C., in particular from 30 to 130° C. During the residence time of about 6 hours, preferably 5 hours, in particular 4 hours, the mixture of raw materials is agitated at from 10 to 70 rpm, preferably from 15 to 65 rpm, in particular from 20 to 60 rpm. The resultant precrystallized and, respectively, predried mixture of raw materials is post-dried in a downstream vessel, likewise evacuated, at from 90 to 180° C., preferably from 100 to 170° C., in particular from 110 to 160° C., for from 2 to 8 hours, preferably from 3 to 7 hours, in particular from 4 to 6 hours.

In the preferred extrusion process for producing the film, the molten polymer material with the additives is extruded through a slot die and quenched, in the form of a substantively amorphous prefilm, on a chill roll. This film is then reheated and oriented longitudinally and transversely or transversely and longitudinally, or longitudinally, transversely, and again longitudinally and/or transversely. The stretching temperatures are generally above the glass transition temperature T_{g} of the film by from 10 to 60° C. It is usual for the stretching ratio for longitudinal stretching to be from 2 to 6, in particular from 3 to 4.5, while that for transverse stretching is from 2 to 5, in particular from 3 to 4.5, and that for any second longitudinal or transverse stretching carried out is from 1.1 to 5. The first longitudinal stretching may also be carried out at the same time as the transverse stretching (simultaneous stretching). Heat-setting of the film follows at oven temperatures of from 180 to 260° C., in particular from 220 to 250° C. The film is then cooled and wound up.

It was surprising that a film with hydrolysis resistance and heat resistance and with the property profile required could be produced without any technical problems (such as caking in the dryer) by using masterbatch technology combined with suitable predrying and/or precrystallization and the use of hydrolysis stabilizers. When comparison is made with a film not provided with the appropriate materials, there is also no adverse change, within the limits of accuracy of measurement, in the Yellowness Index of the film.

The combined properties of the film of the invention make it suitable for many varied applications, for example for flexible conductors in the automotive industry, for ribbon cables, for flexible printed circuits, for capacitors, for interior decoration, for the construction of exhibition stands, for exhibition requisites, as displays, for placards, for the protective glazing of machinery or of vehicles, in the lighting sector, in the fitting out of shops or of stores, as a promotional item or laminating medium, for greenhouses, applications in the construction sector, or for illuminating advertising profiles, electrical applications, etc.

The examples are used below to describe the invention in further detail, without limiting the same. Film properties were tested as follows:

Light Transmittance (transparency)

For the purposes of the present invention, light transmittance is the ratio between the total transmitted light to the amount of incident light. Light transmittance was measured to ASTM D1003 using the ®HAZEGARD plus test equipment from Byk Gardener, Germany.

Yellowness Index

Yellowness Index (YI) is the deviation from colorlessness in the “yellow” direction and was measured to DIN 6167.

Standard Viscosity (SV) and Intrinsic Viscosity (IV)

Standard viscosity SV was measured by a method based on DIN 53726 on a 1% strength solution in dichloroacetic acid (DCA) at 25° C. SV (DCA)=(hᵣₑₗ−1)×1 000. The intrinsic viscosity (IV) is calculated from the standard viscosity (SV) as follows: IV=[η]=6.907·10⁻⁴ SV (DCA)+0.063096 [dl/g]

Surface Defects

Surface defects were determined visually.

Shrinkage

Shrinkage was measured to DIN 40634 at 150° C. with a residence time of 15 minutes.

Mechanical Properties

Modulus of elasticity and tensile stress at break were determined longitudinally and transversely to ISO 527-1-2.

Heat/moisture Test (long-term moisture test)

In this test, the film was aged in an autoclave for 1000 h at 85° C. and 95% relative humidity, and tensile stress at break was then measured longitudinally and transversely. Tensile stress at break has to be more than 100 N/mm² if the requirements of the automotive industry are to be met.

Resistance to High Temperatures

Resistance to high temperatures was determined to IPC TM 650 2.4.9 after 1000 h of heat-conditioning at 130° C. in a circulating air drying cabinet. After this heat-conditioning, tensile stress at break to ISO 527-1-2 has to be more than 100 N/mm² if the requirements of the automotive industry are to be met.

Weathering (bilateral), UV Resistance

UV resistance was tested as follows to the ISO 4892 test specification:

| | |
|---|---|
| Test equipment | Atlas Ci 65 Weather-Ometer (Atlas, England) |
| Test conditions | to ISO 4892, i.e. artificial weathering |
| Irradiation time | 1000 hours (per side) |
| Irradiation | 0.5 W/m², 340 nm |
| Temperature | 63° C. |
| Relative Humidity | 50% |
| Xenon lamp | internal and external filter made from borosilicate |
| Irradiation cycles | 102 minutes of UV light, then 18 minutes of UV |
| | light with water spray on the specimens, then again |
| | 102 minutes of UV light, etc. |

Fire Performance

Fire performance was determined to DIN 4102, Part 2, construction materials class B2 and to DIN 4102 Part 1, construction materials class B1, and also to the UL 94 test.

Determination of Minimum Sealing Temperature

Hot-sealed specimens (sealed seam 20 mm×100 mm) were produced using Brugger HSG/ET sealing equipment, by sealing the film at different temperatures with the aid of two heated sealing jaws at a sealing pressure of 2 bar and with a sealing time of 0.5 s. From the sealed specimens, test strips of 15 mm width were cut. The T-sealed seam strength was measured as in the determination of sealed seam strength. The minimum sealing temperature is the temperature at which a sealed seam strength of at least 0.5 N/15 mm is achieved.

Sealed Seam Strength

To determine sealed steam strength, two film strips of width 15 mm were placed one on top of the other and sealed at 130° C. with a sealing time of 0.5 s and a sealing pressure of 2 bar (apparatus: Brugger model NDS, single-side-heated sealing jaw). The sealed seam strength was determined by the T-peel method.

All of the films were weathered bilaterally to the test specification ISO 4892, in each case for 1000 hours per side using the Atlas Ci 65 Weather Ometer and then tested for mechanical properties, discoloration, surface defects, and glass.

### EXAMPLES

The examples and comparative examples below in each case concern opaquely pigmented single- or multilayer films of varying thickness, produced on an extrusion line. Unless otherwise stated, percentages are percentages by weight.

The polyethylene terephthalate (clear polymer) from which the opaquely pigmented film was produced had standard viscosity SV (DCA) of 810 (polyethylene terephthalate RT49 from KoSa, Germany) or standard viscosity SV (DCA) of 770 (polyethylene terephthalate 4020 from KoSa, Germany).

The additives were fed in the form of the following masterbatches:

Masterbatch MB1:

10% of titanium dioxide (anatase type, average particle size 0.2 μm, from Sachtleben, Germany), and

90% of polyethylene terephthalate

Masterbatch MB2:

50% of titanium dioxide (rutile type, average particle size 0.2 μm, from DuPont, Germany), and

50% of polyethylene terephthalate

Masterbatch MB3:

45% of barium sulfate (®Blanc fixe XR-HX from Sachtleben Chemie GmbH, Germany),

700 ppm of optical brightener, and

55% of polyethylene terephthalate

Masterbatch MB4:

20% of Pigment Blue 28 (a CoAl₂O₄ spinel; Cobalt Blue from Degussa AG, Germany), and

80% of polyethylene terephthalate

The following masterbatches were used to improve hydrolysis resistance:

Masterbatch MB5:

6% of phenolic hydrolysis stabilizer (®Irganox B561, a blend made from 80% of Irgafos® 168 and 20% of ®Irganox 1010, Ciba Specialty Chemicals, Basle)

94% of polyethylene terephthalate

Bulk density: 750 kg/m³

Masterbatch MB6:

20% a polymeric polycarbodimide (®Stabaxol P from Rhein Chemie, Mannheim, Germany)

80% of polyethylene terephthalate

Bulk density: 750 kg/m³

The following masterbatch was used to improve UV resistance:

Masterbatch MB7:

20% 2-(4,5-diphenyl-[1,3,5]triazin-2-yl)-5-hexyloxyphenol (®Tinuvin 1577 from Ciba Specialty Chemicals, Switzerland) and

80% of polyethylene terephthalate

Bulk density: 780 kg/m³

The following masterbatch was used to improve slip properties:

Masterbatch MB8:

comprises 10 000 ppm of ®Sylobloc 44H (Grace, Germany) alongside PET.

The following masterbatch was used to render the film flame-retardant:

Masterbatch MB9:

25% of bis(5-ethyl-2-methyl-2-oxo-2λ5-[1,3,2]dioxaphosphinan-5-ylmethyl methane phosphonate) (®Amgard P1045 from Albright & Wilson Americas, USA), and

75% of polyethylene terephthalate

### Example 1

An opaquely pigmented single-layer film of 75 μm thickness was produced and comprised 49% of polyethylene terephthalate (RT49), 6% of MB1, and 10% of MB6. The film also comprised 35% of directly-arising regrind.

The mixture of the individual components was charged at room temperature from separate feed vessels to a vacuum dryer which traversed a temperature profile of from 25 to 130° C. from the time of charging to the end of the residence time. During the residence of about 4 hours, the raw material mixture was stirred at 61 revolutions per minute (rpm).

The precrystallized or predried raw material mixture was then after-dried for 4 hours in a hopper at 140° C., again in vacuo. A single-layer film (monofilm) of thickness 75 μm was then produced by the extrusion process described.

### Example 2

The monofilm produced by a method based on example 1 comprised 8.0% of MB1, 10% of MB6, and 4% of MB8 and 35% of directly-arising regrind, alongside polyethylene terephthalate RT49. The raw material mixture was predried as described in example 1.

### Example 3

Using a method based on example 1, a monofilm of 75 μm thickness was produced. It comprised 10% of MB2, 10% of MB6, and 4% of MB8 and 35% of directly-arising regrind, alongside PET RT49. The raw material mixture was predried as described in example 1.

### Example 4

The film from example 1 was post-treated for a residence time of 60 seconds at a temperature of 200° C. in an oven, very substantially without tension.

### Example 5

The film from example 1 was chemically post-treated using trichloroacetic acid.

### Example 6

Using a method based on example 1, a monofilm of 75 μm thickness was produced. This film differed from the film of example 1 in that it comprised 7.5% of MB4 instead of 6% of MB1.

### Example 7

A hydrolysis-resistant ABA film was produced using the following mixing specification:

| | |
|---|---|
| Base layer (thickness 72 μm): | 57% of polyethylene terephthalate 4020, |
| | 3% of MB2, |
| | 5% of MB6, and also |
| | 35% of directly-arising regrind |
| Outer layers A (each 1.5 μm): | 83% of polyethylene terephthalate 4020, |
| | 7% of MB8, and also |
| | 10% of MB5 |

### Comparative Example C1

As described in example 1, a monofilm of 75 μm thickness was produced. However, this film differed from the film of example 1 in that it comprised no hydrolysis stabilizer.

The properties of the films are given in the table below:

TABLE 1

| | | | Examples | | | | | | | |
|---|---|---|---|---|---|---|---|---|---|---|
| Property profile | | | 1 | 2 | 3 | 4 | 5 | 6 | 7 | C1 |
| Thickness | | μm | 75 | 75 | 75 | 75 | 75 | 75 | 75 | 75 |
| Light transmission | | % | 70 | 69 | 30 | 70 | 70 | 58 | 45 | 69 |
| Yellowness Index (YID) | | | 11 | 10 | 16 | 10 | 11 | | 13 | 11 |
| Shrinkage | longitudinal | % | 1.1 | 1.1 | 1.0 | 0.7 | 1.1 | 1.0 | 1.0 | 1.1 |
| | transverse | % | 0.8 | 0.9 | 0.8 | 0.5 | 0.8 | 0.8 | 1.0 | 0.8 |
| Tensile stress at | longitudinal | N/mm² | 200 | 190 | 190 | 200 | 200 | 200 | 200 | 200 |
| break | transverse | N/mm² | 290 | 290 | 300 | 300 | 280 | 290 | 280 | 290 |
| Modulus of | longitudinal | N/mm² | 4200 | 4200 | 4200 | 4250 | 4200 | 4250 | 4200 | 4200 |
| elasticy | transverse | N/mm² | 5200 | 5200 | 5300 | 5250 | 5200 | 5150 | 5100 | 5200 |

| | | | | | | | | |
|---|---|---|---|---|---|---|---|---|
| Heat/moisture test | yes | yes | yes | yes | yes | yes | yes | no |
| Resistance to high temperature | yes | yes | yes | yes | yes | yes | yes | no |
| Reactive surface | − | − | − | − | + | − | − | − |
| Pigmentation | white | white | white | white | white | blue | white | white |

yes = test passed
no = test not passed

### Example 8

Example 1 was repeated, but modified in that both sides of the film were coated. To this end, a reverse gravure-roll coating process was used to coat both sides of the film with an aqueous dispersion after longitudinal stretching. The dispersion comprised

| | |
|---|---|
| 4.20% | of hydrophilic polyester (PET/IPA polyester containing the |
| | sodium salt of 5-sulfoisophthalic acid, SP41, Ticona, USA), |
| 0.15% | of colloidal silica (® Nalco 1060, Deutsche Nalco Chemie, |
| | Germany) as antiblocking agent, |
| 0.15% | of ammonium carbonate (Merck, Germany) as pH buffer, |
| | and water. |

The wet application weight was 2 g/m² per coated side. The calculated thickness of the coating after transverse orientation was 40 nm.

### Example 9

A hydrolysis-resistant and UV-resistant ABA film of 75 μm thickness was produced.

Base layer (thickness 72 μm):

40% of PET 4020, 10% of MB1, 10% of MB6, 5% of MB7, and also 35% of directly-arising regrind.

Outer layers A (thickness of each 1.5 μm): 93% of PET 4020, and also 7% of MB8.

### Example 10

A hydrolysis-resistant and UV-resistant ABA film was produced.

Base layer (thickness 72 μm):

27% of PET 4020, 30% of MB3, 5% of MB6, 3% of MB7 (0.6% of UV stabilizer), and also 35% of directly-arising regrind.

Outer layers A (thickness of each 1.5 μm):

78% of PET 4020, 7% of MB8, 10% of MB5, and also 5% of MB7 (1% of UV stabilizer).

Both sides of the film have a coating, the method being based on example 8.

### Example 11

Coextrusion was used to produce a sealable ABC film of 12 μm thickness.

Base layer (thickness 10 μm):

50% of PET 4020, 10% of MB1, 10% of MB6, and also 35% of directly-arising regrind.

The thermoplastic used for the sealable outer layer A of thickness 1 μm was a copolyester made from 78 mol % of ethylene terephthalate and 22 mol % of ethylene isophthalate (prepared by transesterification in the presence of a manganese catalyst, Mn concentration: 100 ppm). That layer also comprised 3.0% of masterbatch MB8 as antiblocking agent.

The outer layer C of thickness 1 μm comprised 7% of masterbatch MB8 alongside 93.0% of PET 4020.

### Example 12

A hydrolysis-resistant, opaquely pigmented, coextruded sealable A-B-C film of 12 μm thickness was produced as described in example 11. Unlike in example 11, reverse gravure-roll coating was used to single-side-coat the non-sealable outer layer C with an aqueous dispersion after longitudinal stretching. The makeup of the dispersion was as in example 8. The wet application weight was 2 g/m². The calculated thickness of the coating after transverse stretching was 40 nm.

### Example 13

Using a method based on example 1, a monofilm of 75 μm thickness was produced. The film differed from the film of example 1 in that it now also comprised 3% of MB9 (0.75% of flame retardant).

### Example 14

The film from example 13 was post-treated for a residence time of 60 seconds at a temperature of 200° C. in an oven, very substantially without tension.

### Example 15

The film from example 13 was chemically post-treated using trichloroacetic acid.

### Example 16

Using a method based on example 1, a monofilm of 75 μm thickness was produced. The film differed from the film of example 1 in that it now comprised 7.5% of MB4 (1.5% of Pigment Blue 28) instead of 6% of MB1.

The film was corona-treated on one side. The intensity selected was such as to give a surface tension of more than 45 mN/m after the treatment.

### Comparative Example C2

Using a method based on example 13, a monofilm of 75 μm thickness was produced. It differed from the film of example 13 in that it comprised no hydrolysis stabilizer.

The properties of the films are found in table 2 below.

TABLE 2

| | | Examples | | | | | | | | | | |
|---|---|---|---|---|---|---|---|---|---|---|---|---|
| Property profile | | | 8 | 9 | 10 | 11 | 12 | 13 | 14 | 15 | 16 | C2 |
| Thickness | | [μm] | 75 | 75 | 75 | 12 | 12 | 75 | 75 | 75 | 75 | 75 |
| Light transmission (transparency) | | [%] | 68 | 63 | 17 | 75 | 75 | 71 | 70 | 70 | 58 | 70 |
| Yellowness Index (YID) | | | 10 | 10 | 8 | 6 | 6 | 11 | 11 | 11 | | 12 |
| Shrinkage | longitudinal | [%] | 1.1 | 1 | 1 | 1 | 1.1 | 1.1 | 0.7 | 1.1 | 1 | 1.1 |
| | transverse | [%] | 0.8 | 0.8 | 1 | 0.2 | 0.1 | 0.9 | 0.5 | 0.8 | 0.8 | 0.8 |
| Tensile stress at break | longitudinal | [N/mm²] | 200 | 200 | 180 | 260 | 260 | 190 | 200 | 200 | 200 | 190 |
| | transverse | [N/mm²] | 300 | 280 | 250 | 260 | 270 | 280 | 290 | 280 | 290 | 280 |
| Modulus of elasticity | longitudinal | [N/mm²] | 4250 | 4200 | 3800 | 4700 | 4700 | 4150 | 4200 | 4200 | 4250 | 4200 |
| | transverse | [N/mm²] | 5250 | 5150 | 4900 | 5000 | 5000 | 5100 | 5200 | 5200 | 5150 | 5150 |

| Heat/moisture test | | | yes | yes | yes | yes | yes | yes | yes | yes | yes | no |
|---|---|---|---|---|---|---|---|---|---|---|---|---|
| Resistance to high temperature | | | yes | yes | yes | yes | yes | yes | yes | yes | yes | no |
| UV-resistance (absorption) | | [nm] | <380 | <290 | <290 | <380 | <380 | <380 | <380 | <380 | <380 | <380 |
| Flame retardancy (fire cl.) | | | | | | | | B1, B2, | B1, B2, | B1, B2, | | B1, B2, |
| Coating (adhesion) | | | ++ | | ++ | | ++ | | | | | |
| Reactivesurface | | | | | | | | | | + | + | |
| Minimum scaling temperatur | A/A | [° C.] | | | | 94 | 95 | | | | | |
| Seal seam strength | A/A | [N/15 mm] | | | | 2.4 | 2.4 | | | | | |
| Pigmentation | | | white | white | white | white | white | white | white | white | blue | white |
| Surface tension | | [mN/m] | 40 | 40 | 40 | 40 | 40 | 40 | 40 | 40 | 48 | 40 |

++ = improved adhesion
yes = test passed
no = test not passed

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined bye the appended claims and their equivalents.

The priority document, German Patent Application No. 101 26 149.7, filed May 30, 2001 is incorporated herein by reference in its entirety.

As used herein and in the following claims, articles such as “the”, “a” and “an” can connote the singular or plural.

All documents referred to herein are specifically incorporated herein by reference in their entireties.

We claim:

1. A single- or multilayer opaquely pigmented, biaxially oriented film which comprises at least one crystallizable thermoplastic as main constituent, at least one pigment, and at least one monomeric, oligomeric, or polymeric carbodiimide as hydrolysis stabilizer.

2. The film as claimed in claim 1, wherein the oligomeric, or polymeric carbodiimide has a molecular weight of from 2000 to 50 000.

3. The film as claimed in claim 1, wherein the proportion of the monomeric, oligomeric, or polymeric carbodiimide is from 0.1 to 5.0% by weight, based on the weight of the single-layer film or of the layer provided therewith in the multilayer film.

4. The film as claimed in claim 1, which also comprises a phenolic compound or an oxazoline as further hydrolysis stabilizer.

5. The film as claimed in claim 4, wherein the phenolic compound is a sterically hindered phenol, thiobisphenol, alkylidenebisphenol, or alkylphenol, or a hydroxybenzyl compound, or an acylaminophenol, and/or a hydroxyphenyl propionate.

6. The film as claimed in claim 4, wherein the proportion of the phenolic compound is from 0.1 to 8.0% by weight, based on the weight of the film or of the layer provided therewith in the case of the multilayer film.

7. The film as claimed in claim 4, wherein the phenolic compound has been combined with at least one organic phosphite.

8. The film as claimed in claim 7, wherein the ratio by weight of the phenolic compound to the organic phosphite is from 10:90 to 90:10.

9. The film as claimed in claim 1, which comprises a mixture of from 0.1 to 5% by weight of polymeric carbodiimides and from 0.1 to 5% by weight of a blend of from 30 to 90% by weight of an organic phosphite and from 70 to 10% by weight of a hydroxyphenyl propionate.

10. The film as claimed in claim 1, wherein the proportion of all of the hydrolysis stabilizers together is from 0.2 to 13.0% by weight based on the weight of the film, or of the relevant layer in the multilayer film.

11. The film as claimed in claim 1, whose longitudinal and transverse shrinkages after 15 minutes of heating to 150° C. are in each case less than 2.0%.

12. The film as claimed in claim 1, wherein the pigment is an inorganic white pigment, an inorganic or organic non-neutral-color pigment, an inorganic black pigment, or a mixture of these.

13. The film as claimed in claim 12, wherein the inorganic white pigment is barium sulfate or titanium dioxide.

14. The film as claimed in claim 1, wherein the proportion of the pigments is from 0.2 to 40% by weight, based on the weight of the crystallizable thermoplastic of the single-layer film, or of the relevant layer of the multilayer film.

15. The film as claimed in claim 1, which is also sealable, or has been flame-treated, and/or corona-treated, or chemically pretreated, or coated on one or both of its sides.

16. The film as claimed in claim 15, wherein the film or at least one of its layers comprises a UV stabilizer.

17. The film as claimed in claim 16, wherein the UV stabilizer is a 2-hydroxybenzophenone, a 2-hydroxybenzotriazole, an organonickel compound, a salicylic ester, a cinnamic ester derivative, resorcinol monobenzoate, an oxanilide, a hydroxybenzoic ester, a benzoxazinone, a sterically hindered amine, or a triazine.

18. The film as claimed in claim 16, wherein the UV stabilizer is 2-(4,6-diphenyl-[1,3,5]-triazin-2-yl)-5-hexyloxyphenol, 2,2′-methylenebis[6-benzotriazol-2-yl-4-(1,1,2,2-tetramethylpropyl)phenol] and/or 2,2′-(1,4-phenylene)bis[[1,3]-benzoxazin-4-one].

19. The film as claimed in claim 16, wherein the proportion of the UV stabilizer(s) is from 0.1 to 5.0% by weight, based on the total weight of the single-layer film, or of the relevant layer of the multilayer film.

20. The film as claimed in claim 1, which comprises a flame retardant.

21. The film as claimed in claim 20, wherein the flame retardant is a bromine compound, a chloroparaffin, or any other chlorine compound, antimony trioxide, aluminum hydroxide, or a monomeric or polymeric organic phosphorus compound.

22. The film as claimed in claim 20, wherein the proportion of flame retardant is from 0.5 to 30.0% by weight, based on the total weight of the single-layer film, or of the relevant layer of the multilayer film.

23. A process for producing the film as claimed in claim 1, which comprises using a mixture which encompasses at least one crystallizable thermoplastic as main constituent and encompasses at least one hydrolysis stabilizer, melting the mixture in an extruder and shaping the same by extrusion or coextrusion to give a single- or multilayer film, where the at least one hydrolysis stabilizer is added, prior to extrusion or coextrusion, in the form of a precrystallized or predried masterbatch.

24. The process as claimed in claim 23, wherein the proportion of the at least one hydrolysis stabilizer is from 5 to 50% by weight, based on the total weight of the masterbatch.

25. The process as claimed in claim 23, wherein the substantially amorphous prefilm formed during the extrusion process is quenched on a chill roll and then reheated, longitudinally and/or transversely oriented, and finally heat-set.
